(19) United States
(12) Patent Application Publication
(10) Pub. No.: US 2018/0183701 A1
(43) Pub. Date: Jun. 28, 2018

(54) Method, system and apparatus for using neighbor awareness networking for mesh networking

(71) Applicant: Intel IP Corporation, Santa Clara, CA (US)

(72) Inventors: Emily H. Qi, Gig Harbor, WA (US); Po-Kai Huang, Santa Clara, CA (US); Dave Cavalcanti, Beaverton, OR (US)

(73) Assignee: Intel IP Corporation, Santa Clara, CA (US)

(21) Appl. No.: 15/390,014

(22) Filed: Dec. 23, 2016

(51) Int. Cl. H04L 12/751; H04L 12/931; H04L 12/761; H04L 12/741

(52) U.S. Cl. CPC H04L 45/02; H04L 45/54; H04L 45/16; H04L 49/201

(57) ABSTRACT

The disclosure relates to a method, system and apparatus for providing extending NAN networking capabilities to implement upper layer protocols, including, mesh networking. In an exemplary embodiment, NAN network configuration is used by identifying one or more nearby devices that support a similar Routing Protocol Service. The routing protocol may be Routing Protocol for Low Power and Lossy Network (RPL). The RPL may be identified by sending a NAN Service Discovery frames during a NAN Discovery Windows. Nearby devices which support the RPL may respond to the Service Discovery Frame. Once the nearby devices are identified, NAN Multicast Service Group (NMSG) may be formed and routing tables may be established. Multiple unicast NAN data paths may be established based on the routing tables.

### BACKGROUND

### Field

The disclosure relates to a method, system and apparatus to communicate in a neighbor awareness network (NAN) cluster. Specifically, the disclosure relates to extending NAN networking capabilities to implement upper layer protocols, including, Mesh networking.

### Description of Related Art

Awareness networking enables wireless devices to perform device/service discovery in their proximity Awareness networking includes forming a cluster for devices proximal to each other. One such example is the Network Awareness Neighboring (NAN) protocol. Devices in the same NAN cluster follow the same time schedule through one or more discovery windows (DWs) to facilitate cluster formation and/or to achieve low power operation. Such clusters are particularly useful for device-to-device (D2D) communication. NAN enables Wi-Fi devices to discover devices and/or services in their proximity and set up data path with peer devices. The data path with peer devices is operated at scheduled channels and at scheduled time slots.

A mesh network is a local area network (LAN), wireless local area network (WLAN) or virtual LAN (VLAN) that employs decentralized connection arrangements. A mesh network may have a full mesh topology or a partial mesh topology. In a full mesh topology, each network node (workstation or other device) connects directly to each of the others in the network. In a partial mesh topology, some nodes are connected to all the other nodes, but others are only connected to those nodes with which they exchange the most data.

The recent growth of IoT devices has made it clear that mesh capability among IoT devices is a necessary for expanding D2D applications. The IoT technology depends on the MESH protocol to communicate with other devices. There is a need to properly map the mesh routing control and data traffic over the control and data communication options defined by the NAN layer.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically illustrates a conventional Open System Interconnection (OSI) abstraction;

FIG. 2 shows a conventional NAN device architecture;

FIG. 3 is a schematic block diagram illustration of a system, according to certain embodiments of the disclosure;

FIG. 4 illustrates message flow between the Mesh and MAC layers according to one embodiment of the disclosure;

FIG. 5 schematically illustrates an apparatus for implementing an embodiment of the disclosure; and

FIG. 6 shows an exemplary Availability attribute format.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like. Some demonstrative embodiments are described herein with respect to WiFi communication. However, other embodiments may be implemented with respect to any other communication scheme, network, standard and/or protocol.

Existing mesh networking protocols assume existence of a radio layer (i.e., MAP/PHY layer) where links between neighboring nodes are limited only by the radio characteristics and propagation conditions of the environment. In other words, the mesh layer assumes that nodes within each other's communication range are always available for communication. Consequently, there is minimal interaction between current mesh routing layer and the underlying radio layer. In contrast, Wi-Fi NAN nodes need to set up data paths and synchronize to communicate during the scheduled timeslots and channels.

In one embodiment, the disclosure relates to mapping the mesh layer routing control and data plane traffic over the control and data communication options defined by the NAN layer.

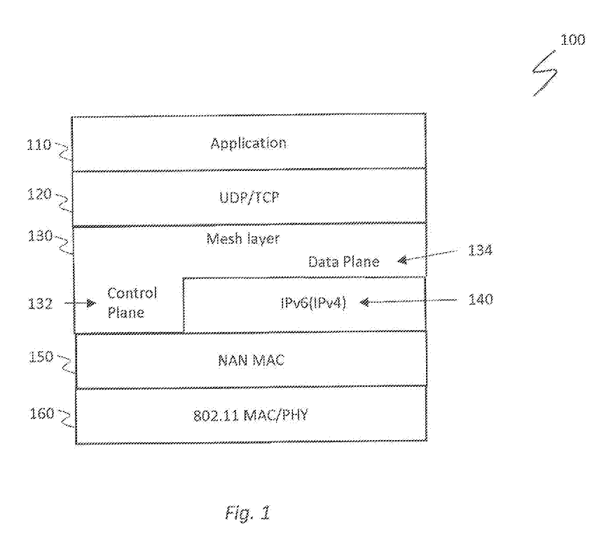

FIG. 1 schematically illustrates a conventional Open System Interconnection (OSI) abstraction. Stack 100 of FIG. 1 may run on any device configured for communication with other devices. Among others, FIG. 1 includes application layer 110, UDP/TCP layer 120, Mesh layer 130 and MAC/PHY layer 160. Application layer 110 can support any application which may engage in communication with application layer of other devices. UDP/TCP 120 layer support the transport layer. Mesh connectivity layer 130 (MCL) allows the device user to connect to a wireless mesh network that uses Wi-Fi or WiMax. Two types of data are associated with MCL 130; Control Plane 132 and Data Plane 134. Control plane 132 communicates control information which may include availability and broadcast time. Control plane 132 may be used to set up mesh networking. Some of control plane packets may be transmitted as MAC management frames directly over MAC layer 150. Others may be IPv6 data frames and transmitted as MAC data frames. Data Plane 134 communicates MCL data and is built over IPv6 layer 140. Instructions from upper layers are communicated to the lower layers through interface signaling. IPv6 layer 140 is a component of the network layer.

NAN (or NAN/MAC) layer 150 is a D2D protocol developed in layer 150 and built on the existing IEEE 802.11 Standard MAC/PHY framework 160. NAN layer 150 enables device discovery and data transmission between peer devices. To enable mesh capability over NAN, it is possible to utilize the existing developed Mesh protocol in Mesh layer 130 to connect with the NAN MAC layer 150. Specifically, the mesh functionality may be viewed as a service in NAN layer 150 such that Mesh layer 130 can instruct NAN MAC layer 150 to publish or subscribe the mesh/routing service to build mesh capability and/or routes.

A core component of Mesh layer 130 is the exchange of routing control or neighbor discover messages. Such control messages are exchanged to verify the links between neighboring devices and to create/update routing tables. The routing protocols also control the frequency of transmitting control messages to update mesh network topology. A basic assumption in conventional mesh routing protocols is that routers (or relay nodes) are always awake and listening to the channel. However, this is not always the case.

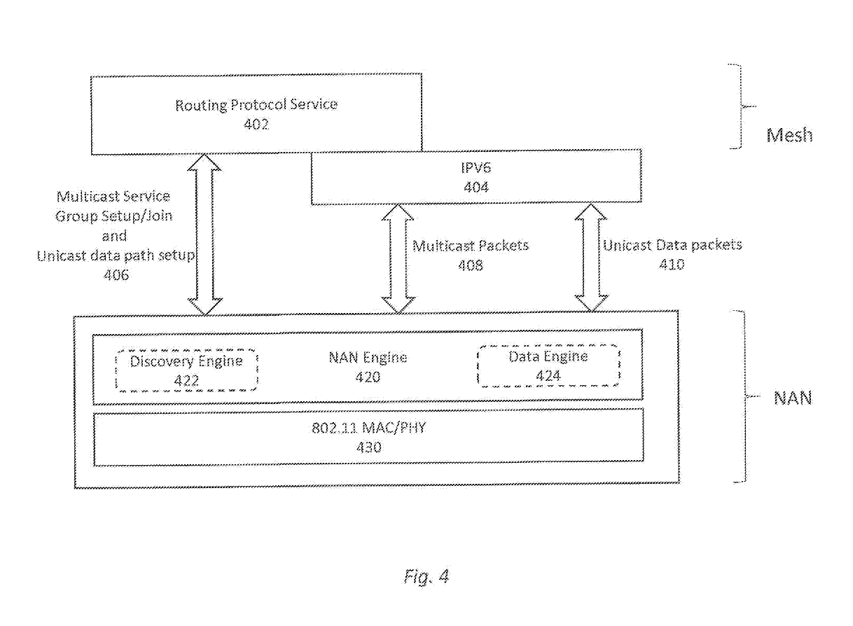

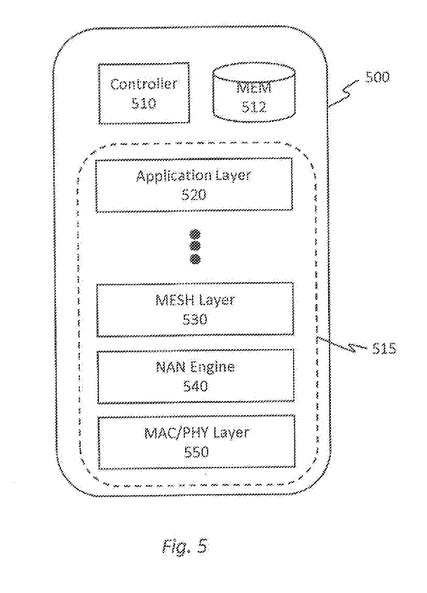

In one embodiment, the components of setting up a mesh networking over NAN layer 150 include: time synchronization, NAN scheduler, device capability exchange, multicast service group and unicast data path. These components will be described in greater detail below in relation to FIGS. 4 and 5.

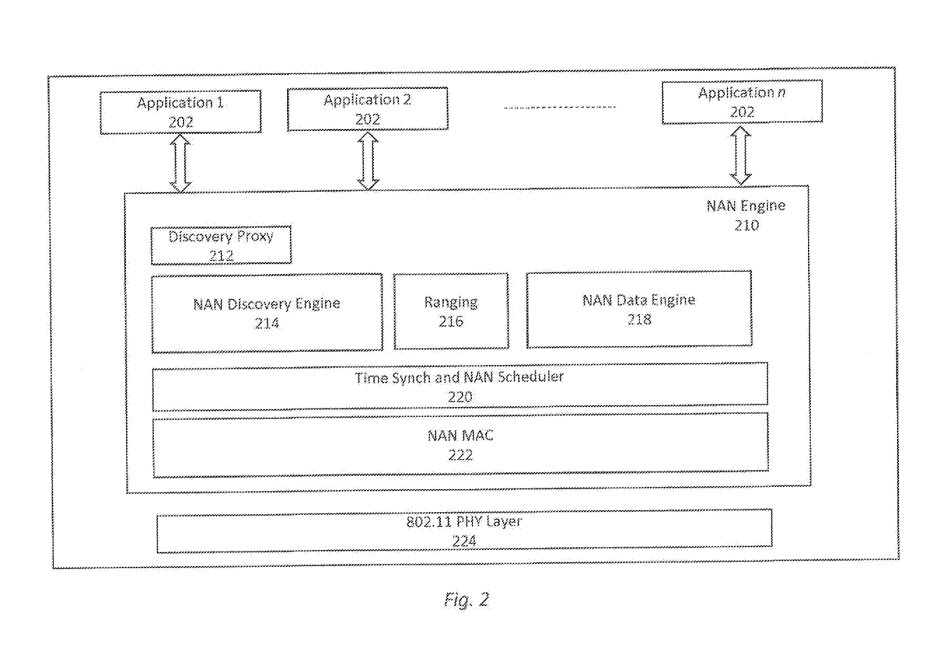

FIG. 2 shows a conventional NAN device architecture. In FIG. 2, applications 202 represents several different applications (apps.) running on the mobile device. Each app may require different communication scheduling. The application(s) interface NAN Engine 210. NAN Engine 210 is at the core of the NAN layer and manages NAN discovery proxy 212, NAN discovery Engine 214, NAN ranging 216, NAN Data Engine 218, Time Synchronization and NAN Scheduler 220 and NAN MAC 222.

Conventional NAN devices transmit a service discovery frame (SDF) for a subscription to a service. The SDF may indicate a registration for the service with a detected NAN proxy device 212. The NAN device may receive a service availability message from the NAN proxy 212 during a reception period, which may be based at least partly on timing information included in the SDF. The subscription enables reception of content at the NAN device from one or more other NAN.

NAN discovery engine 214 provides publication and subscription services to the applications (e.g., Application 202) for service discovery purposes. NAN Discovery Engine 214 may be enhanced with discovery proxy 212.

Ranging service 216 provides peer-to-peer (P2P) ranging using Fine Time Measurement (FTM) as defined, for example, in IEEE 802.11mc Standard. This layer determines an approximate distance to other nearby devices. NAN Data Engine 218 provides NAN data path setup. The NAN data path includes unicast data path and multicast data path.

Time Synchronization and NAN Scheduler (TSNS) 220 may provide different functionalities and services. For example, TSNS 220 may be responsible for synchronizing the mobile device with other devices in the NAN cluster and for scheduling data transmission during each discovery window. In one embodiment, TSNS 220 provides time synchronization and discovery windows between devices in the NAN cluster. The NAN scheduler may provide common availability periods in time and frequency domains for NAN operations.

NAN MAC layer 222 is configured to generate, process or handle one or more NAN messages including NAN Beacon frames or NAN Service Discovery frames. The 802.11 PHY layer 224 is responsible for bit-level transmission between different devices. The NAN protocol uses conventional IEEE 802.11 PHY layer as its PHY layer.

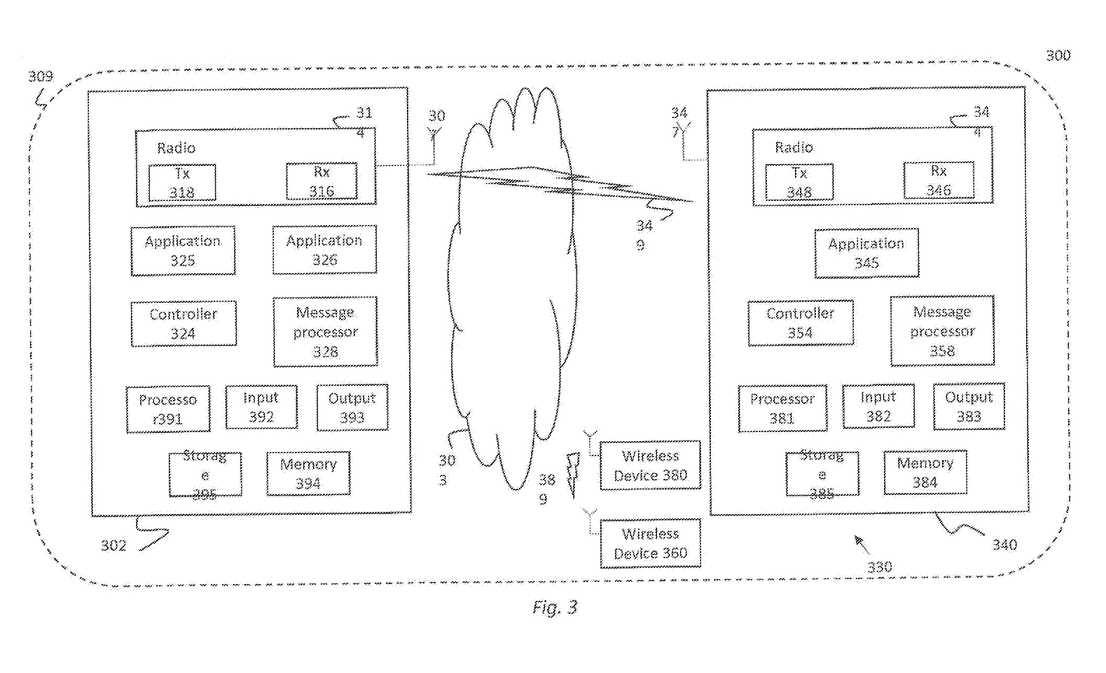

FIG. 3 is a schematic block diagram illustration of a system, according to certain embodiments of the disclosure. System 300 of FIG. 3 shows a wireless communication network including one or more wireless communication devices 302, 340, 360 and 380. Wireless communication devices 302, 340, 360 and 380 may include any device capable of mobile communication, for example, a smart device, laptop, phone, or the like. In some embodiments, devices 302, 340, 360 and 380 may include, operate as, and/or perform the functionality of one or more STAs. For example, device 302 may include at least one station (STA) and device 340 may include at least one STA. In some demonstrative embodiments, devices 302, 340, 360 and 380 may include, operate as, or perform the functionality of one or more WLAN, Wi-Fi, BT/BLE STAs. In some demonstrative embodiments, devices 302, 340, 360 and 380 may include, operate as, or perform the functionality of one or more NAN STAs. In some embodiments, devices 302, 340, 360 and 380 may include, operate as, or perform the functionality of one or more location measurement STAs. An STA may include a logical entity that is a singly addressable instance of a medium access control (MAC) and physical layer (PHY) interface to the wireless medium (WM). The STA may perform any other additional or alternative functionality. For example, devices 302, 340, 360 and 380 may be configured to operate as, or to perform the functionality of an access point (AP) STA or a non-AP STA. An AP may include an entity that contains a STA and provides access to distribution services through the WM for associated STAs.

In one example, a non-AP STA may include a STA that is not contained within an AP. The non-AP STA may perform any other additional or alternative functionality. In one example, device 302 may be configured to operate as, and/or to perform the functionality of an AP, and/or device 340 may be configured to operate as, and/or to perform the functionality of a non-AP STA.

Device 302 may include one or more processor circuitry (“processor”) 391, an input unit 392, an output unit 393, a memory circuitry (“memory”) unit 394, and storage unit 395. Similarly, devices 340, 360 and 380 may include, for example, one or more of processor 381, input unit 382, output unit 383, memory unit 384 and storage unit 385. Memory 382 and storage unit 385 may be combined as one memory module. Devices 302, 340, 360 and 380 may optionally include other suitable hardware components and/or software components. Some or all the components of one or more of devices 302, 340, 360 and 380 may be enclosed in a common housing or packaging, and may be interconnected or operably associated using one or more wired or wireless links. In other embodiments, components of one or more of devices 302, 340, 360 and 380 may be distributed among multiple or separate devices. In still another embodiment, the components may be integrated into a chipset or a monolithic solid state device.

Processor 391 and processor 381 may comprise a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 391 executes instructions, for example, of an Operating System (OS) of device 302 and/or of one or more suitable applications. Processor 381 executes instructions, for example, of an Operating System (OS) of device 340 and/or of one or more suitable applications.

Input units 392 and 382 may include a keyboard, a keypad, a mouse, a touch-screen, a touch-pad, a track-ball, a stylus, a microphone, or other suitable pointing device or input device. Output units 393 and 383 may include a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

Memory units 394 and 384 may include Random Access Memory (RAM), Read Only Memory (ROM), Dynamic RAM (DRAM), Synchronous DRAM (SD-RAM), flash memory, volatile memory, non-volatile memory, cache memory, buffer, short term memory unit, long term memory unit or other suitable memory units. Storage unit 395 and storage unit 385 may include hard disk drive, floppy disk drive, Compact Disk (CD) drive, CD-ROM drive, DVD drive or other suitable removable or non-removable storage units. Memory units 394 and 395 may store data processed by device 302. Memory units 384 and 385 may store data processed by device 340.

Wireless communication devices 302, 340, 360 and 380 may communicate content, data, information and/or signals via WM 303. In some embodiments, wireless medium 303 may include, for example, a radio channel, a cellular channel, a Global Navigation Satellite System channel, an RF channel, a Wireless Fidelity (WiFi) channel, an IR channel, a BT channel or the like.

Wireless communication medium 303 may also include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band. In some embodiments, devices 302, 340, 360 and 380 may include one or more radios including circuitry and/or logic to perform wireless communication between such devices. For example, device 302 may include at least one radio 314 and device 340 may include at least one radio 344.

Radio 314 may include one or more wireless receivers (Rx) including circuitry and/or logic to receive wireless communication signals, RF signals, frames, blocks, transmission streams, packets, messages, data items, and/or data. By way of example, radio 314 may include at least one receiver 316 and radio 344 may include at least one receiver 346. In some embodiments, radios 314 and 344 may include one or more wireless transmitters (Tx) including circuitry and/or logic to transmit wireless communication signals, RF signals, frames, blocks, transmission streams, packets, messages, data items, and/or data. For example, radio 314 may include at least one transmitter 318 and radio 344 may include at least one transmitter 348. In some embodiments, radios 314 and 344 may be configured to communicate over a 2.4 GHz band, a 5 GHz band, an mmWave band, a SIG band, and/or any other band.

Radios 314 and 344 may include, or may be associated with, one or more antennas 307 and 347, respectively. In one example, device 302 may include a single antenna 307. In another example, device 302 may include two or more antennas 307. Similarly, device 340 may include a single antenna or multiple antennas. Antennas 307 and 347 may include any type of antennas suitable for transmitting and/or receiving wireless communication signals, blocks, frames, transmission streams, packets, messages and/or data. For example, antennas may include any suitable configuration, structure and arrangement of one or more antenna elements, components, units, assemblies and/or arrays. Antennas 307 and/or 347 may include, for example, antennas suitable for directional communication, e.g., using beamforming techniques. Antennas 307 and 347 may include a phased array antenna, a multiple element antenna, a set of switched beam antennas, and/or the like. In some embodiments, antennas 307 and 347 may implement transmit and receive functionalities using separate transmit and receive antenna elements. In some embodiments, antennas 307 and 347 may implement transmit and receive functionalities using integrated transmit/receive elements.

In some embodiments, wireless communication devices 302, 340, 360 and 380 may form, and/or may communicate as part of, a WLAN, WiFi, WiFi Direct (WFD) network or WiFi direct services (WFDS). Further devices 302, 340, 360 and 380 may perform awareness networking communications according to an awareness protocol (e.g., a WiFi aware protocol or any other protocol). In some embodiments, devices 302, 340, 360 and 380 may form or be a part of, NAN network or may perform the functionality of one or more NAN devices. Wireless communication medium 303 may include a direct link, for example, a PTP link (“e.g., a WiFi direct P2P link”) or any other PTP link to enable direct communication between wireless communication devices 302, 340, 360 and 380. In other embodiments, wireless devices 302, 340, 360 and 380 may perform the functionality of WFD P2P devices including functionality of a P2P client device, and/or P2P group Owner (GO) device.

In some demonstrative embodiments, device 102 may execute an application 125 and/or an application 126. In some demonstrative embodiments, device 140 may execute an application 145. In some demonstrative embodiments, devices 102, 140, 160 and/or 180 may be capable of sharing, showing, sending, transferring, printing, outputting, providing, synchronizing, and/or exchanging content, data, and/or information, e.g., between applications and/or services of devices 102, 140, 160 and/or 180 and/or one or more other devices.

Devices 302, 340, 360 and 380 may further one or more controllers (interchangeably, controller circuitry) configured to control one or more functionalities of devices 302, 340, 360 and 380 including awareness networking communications, WiFi Aware NAN communication or any other communication between these devices. For example, device 302 may include controller 324 and device 340 may include controller 354. Each controller may be configured to perform and/or trigger one or more functionalities, communications, operations and/or procedures between wireless communication devices. In some embodiments, controller 324 may include circuitry and/or logic (e.g., one or more processors including circuitry and/or logic), memory circuitry and/or logic, Media-Access Control (MAC) circuitry and/or logic, Physical Layer (PHY) circuitry and/or logic, and/or any other circuitry and/or logic configured to perform the functionality of controller 324. One or more functionalities of the controller may be implemented by logic which may be executed by a machine and/or one or more processors. Each controller may comprise hardware, software or a combination of hardware and software.

In one example, controller 324 may include circuitry and/or logic, for example, one or more processors and/or memory including circuitry and/or logic to cause, trigger or control device 302 to perform one or more operations, communications or functionalities. Similarly, controller 354 may include circuitry and/or logic, for example, one or more processors and/or memory including circuitry and/or logic to cause, trigger or control device 140. Such functionalities may include functionalities of a NAN engine or a NAN discovery engine (DE), for example, to process one or more service queries and/or responses, from applications and/or services on devices 302, 340, 360 and 380. Controllers 324 and 354 may be implemented in software. In an exemplary embodiment, controllers 324 and 354 are implemented in software on processor 391 and 381, respectively.

Optionally, device 302 may also include message processor 328 configured to generate, process and/or access one or messages communicated by device 302. Similarly, optional message processor 358 may be configured to generate one or more messages to be transmitted by device 340.

Message processors 328 and 358 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 328 and 358. Message processors 328 and 358 may perform one or more functionalities of a NAN MAC configured to generate, process or handle one or more NAN messages including NAN Beacon frames or NAN Service Discovery frames. At least part of the functionality of message processor 328 may be implemented as part of radio 314. The message processors may be implemented in software running on one or more processor circuitries. For example, a part of message processor 328 functionalities may be implemented as part of controller 324 or as part of any other element of device 302. In some embodiments, at least part of the functionality of controller 324, radio 314, and/or message processor 328 may be implemented by an integrated circuit, for example, a chip (e.g., a System on Chip (SoC)). Message processor 358 may be implemented similarly.

The wireless communication devices of FIG. 3 may include one or more blocks or entities to perform network awareness functionality. For example, a device may perform the functionality of a NAN device including a NAN MAC and a Discovery Engine. For example, controllers 324 and/or 354 may be configured to perform the functionality of the discovery engine. Message processors 328 and/or 358 may be configured to perform the functionality of the NAN MAC. In another example, the functionality of the NAN MAC and/or the Discovery engine may be performed by any other element and/or entity of the wireless devices. Additionally, devices 302, 340, 360 and 380 may perform a discovery process according to the awareness networking scheme to discover each other and to establish a wireless communication cluster or any other link.

Devices 302, 340, 360 and 380 may form one or more NAN clusters in order to publish and/or subscribe for services. A NAN cluster may include an Anchor Master (AM) (also referred to as a “NAN master device” or “anchor device”). The AM may include a NAN device which has the highest rank in the NAN cluster. The NAN data exchange may be reflected by discovery frames which include Publish, Subscribe and/or Follow-Up Service discovery frames (SDF). These frames may include action frames, which may be sent by a device that wishes to publish a service/application, and/or to subscribe to a published service/application at another end.

One of devices 302, 340, 360 and 380 (e.g., device 302) may perform the functionality of an AM. The AM may be configured to transmit one or more beacons. Another device (e.g., device 340) may be configured to receive and process the beacons. Devices 302, 340, 360 and 380 may perform the functionality of NAN devices, (e.g., belonging to a NAN cluster) which may share a common set of NAN parameters, for example, including a common NAN timestamp, and/or a common time period between consecutive DWs. The NAN timestamp may be communicated as part of a NAN beacon frame which may be communicated to the NAN cluster. The NAN timestamp may include a Time Synchronization Function (TSF) value, a cluster TSF value or any other value.

Devices 302, 340, 360 and 380 may be configured to discover one another over a predefined communication channel (i.e., “the social channel). The social channel may be channel 6 in the 2.4 GHz band. Any other channel may be used as the social channel Thus, devices 302, 340, 360 and 380 may transmit SDFs during the plurality of DWs over the social channel. The NAN AM may advertise the time of the DW during which NAN devices may exchange SDFs. In addition, devices 302, 340, 360 and 380 may transmit discovery frames to discover each other and to enable using the services provided by applications 325 and 326. The discovery frame may be transmitted as a group addressed. A group address may be broadcast or multicast in a discovery frame. The discovery frame may be transmitted as any other type of frame. The discovery frame may not require an acknowledgement frame and the transmitter of the discovery frame may not backoff a transmission of the discovery frame.

The discovery frame transmitted by device 302 during the DW may be configured to enable other devices, or services that are running on other devices, to discover the services on device 302. In some embodiments, devices of system 300 may utilize availability information in the form of an Availability Interval Bitmap and/or Further Availability Map, to allow a device of devices 302, 340, 360 and 380, to advertise its availability in terms of at least one channel and one or more timeslots, during which the device may be available (interchangeably, active or awake) to perform post NAN activities. As described below, in certain embodiments, one or more layers above the NAN MAC layer (150, FIG. 1) instruct this layer to increase awake time beyond the conventional awake time under the NAN protocol. In another embodiment, the NAN layer discerns or determines the need for additional awake time based on the volume of messages send/received by higher layers or applications. For example, controller 324 may monitor activities of message processor 328 and decide to increase the frequency of awaking the NAN layer to accommodate the actual or expected activity level.

Wireless device availability information may be communicated as part of an Availability Attribute. The Availability Attribute may include a 32-bit bitmap for 32 timeslots, where each timeslot is 16 milliseconds (ms or TU) long. Each bit that is not zero may represent a timeslot, during which, a device sending the Availability Attribute is to be awakened and made available to send and receive data. As stated, device 302 may be part of a NAN awareness cluster 309. One or more Availability Attribute may be broadcasted to cluster 309 on regular basis. Devices 302, 340, 360 and/or 380 may be configured to communicate according to a Wi-Fi Aware specification and/or any other awareness networking specification, which may be configured to allow a group of devices to discover other devices/services nearby and/or in close proximity Such discovery may be done using low power. Thus, devices 302, 340, 360 and/or 380 of NAN cluster 309 may synchronize to the same clock. All devices of cluster 309 may converge on a time period and DW channel to facilitate the discovery of services of devices 302, 340, 360 and 380 to achieve low power consumption. In some embodiments, when two devices do not hear each other, each device may announce its schedule in the form of availability information indicating one or more available channels and one or more available time slots, independently. such devices may merge and/or adjust their schedules to save power.

Some embodiments are described below with respect to NAN clusters having x-hop peers, where x=1 (also known as the one-hop devices/peers). Some embodiments are described below with respect to the 1-hop devices. However, such embodiments may be extended to an algorithm that considers resource constraints of the x-hop devices, where x is greater than one.

As stated, the mesh networking layer is an upper most layer functionality and includes the control and data planes. The Control Plane is used to setup and maintain mesh topology by discovering routes and updating routing tables (e.g., routing protocol). Some of the control plane packets may be transmitted as MAC management frames directly over MAC layer. Some of the packets may be IPv6 data frames and transmitted as MAC data frames. The Data Plane is used to transmit data and is built over IPv6.

FIG. 4 illustrates message flow between the Mesh and MAC layers according to one embodiment of the disclosure. Specifically, FIG. 4 shows some of the components for setting up mesh networking over NAN. The upper portion of FIG. 4 schematically represents the mesh capability and the lower portion of the figure schematically represents NAN capability.

In FIG. 4, Routing Protocol Service (RPS) 402 establishes and maintains the routing table. In addition, RPS 402 may provide multicasting service 408 by contacting NAN devices. RPS 402 may be defined as a NAN service, for example, a routing protocol service. Among functions of RPS 402, is the group set up service for identifying a device group and setting up group communication. RPS 402 may also add or drop members from the group. Another function of RPS may be directed to unicast messages. In this capacity, RPS 402 may engage in unicast 410 data path setup based on the established routing tables. In an exemplary embodiment, the unicast path setup may include routing a message through one or more hops to its intended destination. As stated, RPS may establish and maintain the routing table. Once the routing table is established, the routing protocol service can call NAN Engine 420 to set up unicast data path with the next hop node.

In an exemplary implementation, NAN Engine 420 need not parse through routing messages from RPS 402. Instead, these messages may be passed to MAC/PHY layer 430. As shown in FIG. 4, both multicast packets 408 and unicast data packets 410 may pass through IPv6 404.

In certain embodiments, NAN Engine 420 may optionally include NAN discovery engine 422 and NAN data engine 424. NAN discovery engine 422 provides publication and subscription services to various applications for service discovery purposes. NAN data engine 424 provides NAN data path setup and termination.

Multicast data path setup—NAN Multicast service group 406 may be established through the RPS 402. Devices that support the same routing protocol can build a mesh network by starting NAN (many-to-many) multicast service groups. For example, assuming Routing Protocol for Low-Power and Lossy Networks (RPL) as mesh routing protocol running on IPv6, a node may decide to operate as root of a RPL and start a NAN multicast service group. The multicast data schedule may be established and/or updated by the multicast group founder or a member of the multicast group. In the many-to-many multicast service group, any device can transmit multicast frames as a source of multicast group.

Unicast data path setup—Once routing table is established or updated, RPS 402 sends Data Path Request, which is primitive to the NAN Engine 420, to setup a one-to-one (1:1) unicast data path with the next-hop node.

In one embodiment, the multicast messages for path discovery and maintenance that are used to establish the routing table for the RPS 402 can be transmitted in NAN multicast data group operating at the NAN multicast data schedule. Unicast messages for path discovery and maintenance can be transmitted in the Unicast Data Path. The multicast and unicast messaging is further discussed below in relation to FIG. 5.

In certain exemplary embodiments, IPv6 404 may be used to transmit data packets between two devices. Such transmission may be Uncast Data Path. The timing and location of data transmission between two nodes of the NAN multicast group may be negotiated and defined in the NAN Availability attribute during data path setup. In one embodiment, the NAN data link may be updated regularly for factors including power saving, interference avoidance or any other purpose. Moreover, any mesh node may send data link schedule update to its peer mesh nodes in the NAN multicast group. The update may be sent in a unicast data path.

Any event may cause data path termination (interchangeably, tear down). In certain embodiments, data path termination may be triggered by the RPS 402 or by NAN Engine 420. For example, if connection loss is detected by NAN Engine 420, the NAN layer may report the connection loss to RPS 402. Once a data path is terminated, RPS 402 may update the routing table.

FIG. 5 schematically illustrates an apparatus for implementing an embodiment of the disclosure. Apparatus 500 of FIG. 5 may be a wireless device (as described in relation to FIG. 3) or it may be integrated to a mobile device. By way of example, device 500 may be implemented in a router, an AP, a smart phone or an IoT device. Device 500 may be implemented in hardware, software or a combination of hardware and software.

Device 500 is shown with controller 510 and memory circuitry 512. The controller may comprise one or more processor circuitries. The processor circuitries may be implemented in hardware, software or a combination of hardware and software. Memory circuitry 512 may comprise storage capacity to store instructions and data. The instructions may be communicated to controller 510. Controller 510 may be implemented in hardware, software or a combination of hardware and software.

Stack 515 is exemplary and shows application layer 520. Application layer 520 may represent many applications running on device 500. For brevity, all the functional layers of stack 515 are not shown. In one embodiment, stack 515 may comprise layers substantially similar to those disclose in relation to FIG. 2. Mesh layer 530 may define a conventional mesh layer configured to execute RPL. Conventional RPL builds destination oriented Directed Acyclic Graphs (DODAG) for routes towards a root node. Conventional RPL also supports downward (one to many) and P2P (up/down) routes in stored or non-stored modes. Nodes can join DODAG as router/relay or as a leaf node. Finally, RPL allows building multiple logical topologies on top of the same physical network (e.g., multiple RPL instances with different objective functions (OF) and multiple DODAGs).

Mesh layer 530 may communicate with the lower layers (NAN Engine 530 and MAC/PHY layer 550) through unicast and/or multicast packets. In an exemplary embodiment, Mesh layer 530 uses NAN Engine 540 to set up and update, among others, a routing table. The routing protocol may be defined as a NAN service (e.g., RPL). In one application, NAN Engine 540 does not parse the routing messages and merely passes the messages to MAC/PHY layer 550. Once established, the routing table may be maintained in the RPS (see FIG. 4).

In one embodiment, device 500 may transmit service discovery advertisement through NAN discovery windows to identify nearby devices. Nearby devices may respond to the advertisement. The response may include device identification and other available device services. These responses may be aggregated to form a NAN multicast group. The NAN multicast group may be associated with a routing table which identifies members of the group.

In one embodiment, device 500 may use NAN timing and synchronization to synchronize itself with other devices in the mesh group (interchangeably, NAN cluster). An exemplary NAN cluster according to certain disclosed embodiments may include all NAN mesh nodes that are synchronized. In certain embodiments, the NAN cluster may include multiple roots or multiple mesh networks.

As stated, device 500 (or any device in its NAN cluster) may transmit NAN service discovery frame in the discovery windows by advertising the routing protocol types it supports. The device may also advertise its capability, for example, as root, relay, leaf, etc. The device may also advertise its future availability channel and timeslots. Device 500 may engage in multicast and/or unicast data transmission.

Other devices (not shown) in proximity of device 500, upon receiving the advertising, may join the NAN Multicast Service Group (NMSG) if they support the same protocol. In one embodiment, a device that is capable to be a root can start a NMSG (many-to-many) by including its multicast service group address and NAN multicast (Wakeup) schedule in the NAN Service Directory frames, if there is no existing NMSG to join. In another embodiment, other devices that are capable to be relay and leaf and support the same routing protocol may join the NMSG. In certain embodiments, there may be multiple NMSGs in the NAN area. In certain embodiments, relay devices may be an NMSG enroller and may relay NMSG information, such as, address, schedule, etc. Once a device has joined an NMSG, the device may can start transmitting multicast messages (i.e., DIO for RPL) for the corresponding routing protocol services at the scheduled channels and time slots (i.e., NAN multicast wakeup schedule). In an exemplary embodiment, the root device may include multicast (wakeup) schedule in the Service Discovery Frame (SDF) and transmit in DW. The root device (e.g., device 500) may also update multicast (wakeup) schedule. A relay device may relay the schedule or transmit its own multicast schedule by including the schedule in SDF and transmitting in DW.

Device 500 may engage in unicast data transmission as described in relation to FIG. 4. In one embodiment, once routing table is established or updated, the routing protocol service (e.g., RPS 402, FIG. 4) may call Data Path Request (not shown) which is primitive to the NAN Engine 540 to set up NAN data path. The data path may be a one-on-one data path with the next hop node. In this manner, the NAN Data Engine (not shown) may be deployed. NAN Data Engine is a layer 2 function that establishes peer-to-peer connectivity. NAN Data Engine establishes NAN Data Path with the next hop using NAN Data Path Request and Response frame. In an exemplary embodiment, the time (time slot) and manner (channels) of data transition between two mesh nodes may be negotiated and defined in the NAN Availability attribute during the data path setup. The communication may be implemented in the Unicast Data Path Schedule. The Unicast data path schedule may be updated for power saving, interference avoidance and for any other purpose. In certain embodiments, any mesh node may send data ling schedule update to its peer mesh nodes.

Device 500 may terminate (tear down) the session. In one embodiment, termination of a data path between two mesh nodes may be initiated by the RPS (e.g. RPS 402, FIG. 4). In certain embodiments, termination of a data path between two mesh nodes may be detected by NAN Engine 450 if a mesh node is moving away or is dysfunctional. In such cases, NAN Engine 450 may report the link error to the upper layer (e.g., mesh layer 530 and application layer 520).

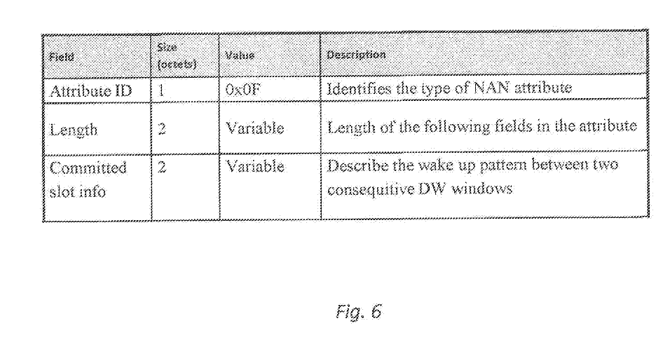

FIG. 6 shows an exemplary Availability attribute format. The Availability attribute includes can carry out the signaling between the mesh nodes. Availability attribute may be carried in the publish/subscribe message from the NAN layer. The extension capability attribute includes field identification, size, value and description. The field may include attribute ID, length and committed slot information. The size may identify each field's allotted sized in octets. The value indicates the expected value of each field and the description provides an explanation of each field.

The following non-limiting examples are provided to further illustrate some of the embodiments of the disclosure.

Example 1 is directed to an apparatus comprising logic and circuitry configured to cause a Neighbor Awareness Networking (NAN) device in a NAN device cluster to: advertise a Routing Protocol Service (RPS) through one or more NAN Service Discovery frames during one or more NAN Discovery Windows (DW); receive one or more responses to the advertisement from a respective one or more devices in a mesh network; form a NAN Multicast Service Group (NMSG) by identifying the one or more devices in the mesh network that support the RPS; establish one or more routing tables for the devices in the NMSG; and setup unicast data paths between devices in the NMSG according to the one or more routing tables.

Example 2 is directed to the apparatus of example 1, wherein the Routing Protocol Service defines Routing over Low Power and Lossy Network (RPL).

Example 3 is directed to the apparatus of example 1, wherein the logic and circuitry are further configured to use NAN time synchronization protocol to synchronize devices in NMSG.

Example 4 is directed to the apparatus of example 1, wherein a first of the NMSG devices transmits a multicast frame as a source of the multicast group.

Example 5 is directed to the apparatus of example 1, wherein each device in the NMSG periodically updates its respective routing table.

Example 6 is directed to the apparatus of example 1, wherein the logic and circuitry are further configured to setup a unicast NAN data path based on the routing table.

Example 7 is directed to the apparatus of example 6, wherein the logic and circuitry are further configured to transmit data packets using the unicast data path.

Example 8 is directed to the apparatus of example 1, wherein the logic and circuitry are further configured to transmit an updated data link schedule.

Example 9 is directed to the apparatus of example 1, wherein the logic and circuitry are further configured to setup a data path between two or more of NMSG devices.

Example 10 is directed to the apparatus of example 9, wherein the logic and circuitry are further configured to transmit a NAN Availability attribute during the data path setup.

Example 11 is directed to a tangible machine-readable non-transitory storage medium that contains instructions, which when executed by one or more processors result in performing operations comprising: advertising a Routing Protocol Service (RPS) through one or more NAN Service Discovery frames during one or more NAN Discovery Windows (DW); receiving one or more responses to the advertisement from a respective one or more devices in the mesh network; forming a NAN Multicast Service Group (NMSG) by identifying the one or more devices in the mesh network that support the RPS; establishing one or more routing tables for the devices in the NMSG; and setting up unicast data path between devices in the NMSG according to the one or more routing tables.

Example 12 is directed to the medium of example 11, wherein the Routing Protocol Service defines Routing over Low Power and Lossy Network (RPL).

Example 13 is directed to the medium of example 11, further comprising using NAN time synchronization protocol to synchronize devices in the NMSG.

Example 14 is directed to the medium of example 11, wherein a first of the NMSG devices transmits a multicast frame as a source of the multicast group.

Example 15 is directed to the medium of example 11, wherein each device in the NMSG periodically updates its respective routing table.

Example 16 is directed to the medium of example 11, further comprising setting up a unicast NAN data path based on the routing table.

Example 17 is directed to the medium of example 16, wherein transmitting data packets in a unicast data path further comprises transmitting an updated data link schedule.

Example 18 is directed to the medium of example 11, wherein establishing routing tables for the NMSG devices further comprises setting up a data path between two or more of NAN multicast group devices.

Example 19 is directed to the medium of example 18, further comprising transmitting a NAN Availability attribute during the data path setup.

Example 20 is directed to the medium of example 11, further comprising terminating the data path.

Example 21 is directed to a method to implement mesh networking by a mobile device using Neighbor Awareness Networking (NAN) protocol, the method comprising: advertising a Routing Protocol Service (RPS) through one or more NAN Service Discovery frames during one or more NAN Discovery Windows (DW); receiving one or more responses to the advertisement from a respective one or more devices in the mesh network; forming a NAN Multicast Service Group (NMSG) by identifying the one or more devices in the mesh network that support the RPS; establishing one or more routing tables for the devices in the NMSG; and setting up unicast data path between devices in the NMSG according to the one or more routing tables.

Example 22 is directed to the method of example 21, wherein the Routing Protocol Service defines Routing over Low Power and Lossy Network (RPL).

Example 23 is directed to the method of example 21, further comprising using NAN time synchronization protocol to synchronize devices in the NMSG.

Example 24 is directed to the method of example 21, wherein a first of the NMSG devices transmits a multicast frame as a source of the multicast group.

Example 25 is directed to the method of example 21, wherein each device in the NMSG periodically updates its respective routing table.

Example 26 is directed to the method of example 21, further comprising setting up a unicast NAN data path based on the routing table.

Example 27 is directed to the method of example 26, wherein transmitting data packets in a unicast data path further comprises transmitting an updated data link schedule.

Example 28 is directed to the method of example 21, wherein establishing routing tables for the NMSG devices further comprises setting up a data path between two or more of NAN multicast group devices.

Example 29 is directed to the method of example 28, further comprising transmitting a NAN Availability attribute during the data path setup.

Example 30 is directed to the method of example 21, further comprising terminating the data path.

Example 30 is directed to a machine-readable storage including machine-readable instructions, when executed, to implement a method or realize an apparatus as claimed in any preceding claim.

Example 31 is directed to a device to implement mesh networking by a mobile device using Neighbor Awareness Networking (NAN) protocol, the method comprising: means for advertising a Routing Protocol Service (RPS) through one or more NAN Service Discovery frames during one or more NAN Discovery Windows (DW); means for receiving one or more responses to the advertisement from a respective one or more devices in the mesh network; means for forming a NAN Multicast Service Group (NMSG) by identifying the one or more devices in the mesh network that support the RPS; means for establishing one or more routing tables for the devices in the NMSG; and means for setting up unicast data path between devices in the NMSG according to the one or more routing tables.

While the principles of the disclosure have been illustrated in relation to the exemplary embodiments shown herein, the principles of the disclosure are not limited thereto and include any modification, variation or permutation thereof.

What is claimed is:

1. An apparatus comprising logic and circuitry configured to cause a Neighbor Awareness Networking (NAN) device in a NAN device cluster to
advertise a Routing Protocol Service (RPS) through one or more NAN Service Discovery frames during one or more NAN Discovery Windows (DW);
receive one or more responses to the advertisement from a respective one or more devices in a mesh network;
form a NAN Multicast Service Group (NMSG) by identifying the one or more devices in the mesh network that support the RPS;
establish one or more routing tables for the devices in the NMSG; and
setup unicast data paths between devices in the NMSG according to the one or more routing tables.

2. The apparatus of claim 1, wherein the Routing Protocol Service defines Routing over Low Power and Lossy Network (RPL).

3. The apparatus of claim 1, wherein the logic and circuitry are further configured to use NAN time synchronization protocol to synchronize devices in NMSG.

4. The apparatus of claim 1, wherein a first of the NMSG devices transmits a multicast frame as a source of the multicast group.

5. The apparatus of claim 1, wherein each device in the NMSG periodically updates its respective routing table.

6. The apparatus of claim 1, wherein the logic and circuitry are further configured to setup a unicast NAN data path based on the routing table.

7. The apparatus of claim 6, wherein the logic and circuitry are further configured to transmit data packets using the unicast data path.

8. The apparatus of claim 1, wherein the logic and circuitry are further configured to transmit an updated data link schedule.

9. The apparatus of claim 1, wherein the logic and circuitry are further configured to setup a data path between two or more of NMSG devices.

10. The apparatus of claim 9, wherein the logic and circuitry are further configured to transmit a NAN Availability attribute during the data path setup.

11. A tangible machine-readable non-transitory storage medium that contains instructions, which when executed by one or more processors result in performing operations comprising:
advertising a Routing Protocol Service (RPS) through one or more NAN Service Discovery frames during one or more NAN Discovery Windows (DW);
receiving one or more responses to the advertisement from a respective one or more devices in the mesh network;
forming a NAN Multicast Service Group (NMSG) by identifying the one or more devices in the mesh network that support the RPS;
establishing one or more routing tables for the devices in the NMSG; and
setting up unicast data path between devices in the NMSG according to the one or more routing tables.

12. The medium of claim 11, wherein the Routing Protocol Service defines Routing over Low Power and Lossy Network (RPL).

13. The medium of claim 11, further comprising using NAN time synchronization protocol to synchronize devices in the NMSG.

14. The medium of claim 11, wherein a first of the NMSG devices transmits a multicast frame as a source of the multicast group.

15. The medium of claim 11, wherein each device in the NMSG periodically updates its respective routing table.

16. The medium of claim 11, further comprising setting up a unicast NAN data path based on the routing table

17. The medium of claim 16, wherein transmitting data packets in a unicast data path further comprises transmitting an updated data link schedule.

18. The medium of claim 11, wherein establishing routing tables for the NMSG devices further comprises setting up a data path between two or more of NAN multicast group devices.

19. The medium of claim 18, further comprising transmitting a NAN Availability attribute during the data path setup.

20. The medium of claim 11, further comprising terminating the data path.

21. A method to implement mesh networking by a mobile device using Neighbor Awareness Networking (NAN) protocol, the method comprising: advertising a Routing Protocol Service (RPS) through one or more NAN Service Discovery frames during one or more NAN Discovery Windows (DW);
receiving one or more responses to the advertisement from a respective one or more devices in the mesh network;
forming a NAN Multicast Service Group (NMSG) by identifying the one or more devices in the mesh network that support the RPS;
establishing one or more routing tables for the devices in the NMSG; and
setting up unicast data path between devices in the NMSG according to the one or more routing tables.

22. The method of claim 21, wherein the Routing Protocol Service defines Routing over Low Power and Lossy Network (RPL).

23. The method of claim 21, further comprising using NAN time synchronization protocol to synchronize devices in the NMSG.

24. The method of claim 21, wherein a first of the NMSG devices transmits a multicast frame as a source of the multicast group.

25. The method of claim 21, wherein each device in the NMSG periodically updates its respective routing table.

26. The method of claim 21, further comprising setting up a unicast NAN data path based on the routing table

27. The method of claim 26, wherein transmitting data packets in a unicast data path further comprises transmitting an updated data link schedule.

28. The method of claim 21, wherein establishing routing tables for the NMSG devices further comprises setting up a data path between two or more of NAN multicast group devices.

29. The method of claim 28, further comprising transmitting a NAN Availability attribute during the data path setup.

30. The method of claim 21, further comprising terminating the data path.
